(19) United States
(12) Patent Application Publication
(10) Pub. No.: US 2016/0352715 A1
(43) Pub. Date: Dec. 1, 2016

(54) SYSTEM AND METHOD FOR AUTHENTICATING A DRIVER

(71) Applicant: HCL Technologies Limited, Noida (IN)

(72) Inventors: Navin SAINI, Noida (IN); Gourik Kumar BORA, Noida (IN); Vishal Chaudhary, Noida (IN)

(21) Appl. No.: 15/081,276

(22) Filed: Mar. 25, 2016

(30) Foreign Application Priority Data
May 27, 2015 (IN) 1524/DEL/2015

(51) Int. Cl. H04L 29/06; H04L 29/08

(52) U.S. Cl. CPC H04L 63/08; H04L 67/12; H04L 63/105

(57) ABSTRACT

The present disclosure relates to system(s) and method(s) for driver authentication based on his driving style. Initially, the system is configured to generate a driver profile based on the driving style of an authorized user of a vehicle, wherein the driving style is captured from a plurality of sensors in the vehicle while the authorized user is driving the vehicle. The reference data comprises a point of contact of the authorized user with an internal component, a pressure applied by the authorized user over the internal component, and one or more external parameters. Once the driver profile is generated, in the next step, the system captures a real-time data from the plurality of sensors, wherein the vehicle is driven by a driver. Finally, the system is configured to authenticate the driver based on the comparison of the real-time data with the driver profile.

### CROSS-REFERENCE TO RELATED APPLICATIONS AND PRIORITY

The present application claims benefit from Indian Complete Patent Application No. 154/DEL/2015, filed on May 27, 2015, the entirety of which is hereby incorporated by reference.

### TECHNICAL FIELD

The present disclosure generally relates to the field of theft detection, and more particularly, to a system and method for vehicle theft detection and driver authentication using driving style.

### BACKGROUND

The number of vehicles used over the globe is increasing exponentially. Vehicles play a vital role in human transport from one place to another. With the increase in the number of vehicles, the number of vehicle thefts reported every year has also increased marginally. To address this problem, a central locking system inside the vehicle is used which can only be operated by the vehicle keys. However, if the vehicle keys are stolen, there are no means by which the vehicle theft can be detected or prevented.

Some of the vehicles use biometric authentication, in which the user needs to provide his biometric sample such as fingerprint, face recognition and the like for accessing the vehicle. However, the biometric samples of the user can be replicated and can be used by an intruder. Once the biometric security is breached, there is no way in which the vehicle theft can be detected or prevented. Further, some of the vehicles use GPS tracking for detecting the current location of the car. However, the GPS tracking is not foolproof and can be misguided.

Based on the above, there is a need for a system and method that can detect vehicle theft and can authenticate the driver based on behavioral biometrics rather than biometric samples.

### SUMMARY

This summary is provided to introduce aspects related to systems and methods for authenticating a driver and the aspects are further described below in the detailed description. This summary is not intended to limit the scope of the claimed subject matter.

In one embodiment, a method for driver authentication based on his driving style is disclosed. Initially a processor is configured to generate a driver profile based on driving style of an authorized user of a vehicle, wherein the driving style is captured from the authorized user by capturing reference data from a plurality of sensors. The reference data includes a point of contact of the authorized user with an internal component of the vehicle, a pressure applied by the authorized user over the internal components, and one or more external parameters. Further, the processor is configured to generate the driver profile based on the reference data. Once the driver profile is generated, in the next step, the processor is configured to capture a real-time data from the plurality of sensors when the vehicle is driven by a driver. Finally, the processor is configured to authenticate the driver based on the comparison of the real-time data with the driver profile.

In one embodiment, a system for driver authentication based on his driving style is disclosed. The system comprises a memory, a processor coupled to the memory, wherein the processor is configured to execute a plurality of instructions stored in the memory for generating a driver profile based on driving style of an authorized user of a vehicle, wherein the driving style is captured from the authorized user by capturing reference data from a plurality of sensors in the vehicle. The reference data includes a point of contact of the authorized user with an internal component, a pressure applied by the authorized user over the internal component, and one or more external parameters. Further, the processor is configured to generate the driver profile based on the reference data. Once the driver profile is generated, in the next step, the processor is configured to capture a real-time data from the plurality of sensors, wherein the vehicle is driven by a driver. Finally, the processor is configured to authenticate the driver based on the comparison of the real-time data with the driver profile.

In one embodiment, a computer program product having embodied computer program for driver authentication based on his driving style is disclosed. The computer program product includes a program code for generating a driver profile based on a driving style of an authorized user of a vehicle, wherein the driving style is captured from the authorized user by capturing a reference data from a plurality of sensors, wherein the reference data comprises a point of contact of the authorized user with an internal component, a pressure applied by the authorized user over the internal component, and one or more external parameters in which the vehicle is driven. The computer program further includes a program code for capturing a real-time data from the plurality of sensors, wherein the vehicle is driven by a driver. Further, computer program comprises a program code for authenticating the driver based on the comparison of the real-time data with the driver profile.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for authenticating a driver, in accordance with an embodiment of the present subject matter.

FIG. 2 illustrates the system for authenticating the driver, in accordance with an embodiment of the present subject matter.

FIG. 3 illustrates a block diagram for authenticating the driver, in accordance with an embodiment of the present subject matter.

FIGS. 4a and 4b illustrates internal components and a plurality of sensors linked with a vehicle, in accordance with an embodiment of the present subject matter.

### DETAILED DESCRIPTION

The present disclosure relates to systems and methods for driver authentication based on his driving style. Initially, the system is configured to generate a driver profile based on the driving style of an authorized user of a vehicle. The driving style is captured from a plurality of sensors in the vehicle when the authorized user is driving the vehicle. The reference data includes a point of contact of the authorized user with an internal component, a pressure applied by the authorized user over the internal component, and one or more external parameters. Once the driver profile is generated, in the next step, the system captures a real-time data from the plurality of sensors when the vehicle is driven by a driver. Finally, the system is configured to authenticate the driver based on the comparison of the real-time data with the driver profile.

While aspects of described system and method for authenticating the driver may be implemented in any number of different computing systems, environments, and/or configurations, the embodiments are described in the context of the following exemplary system.

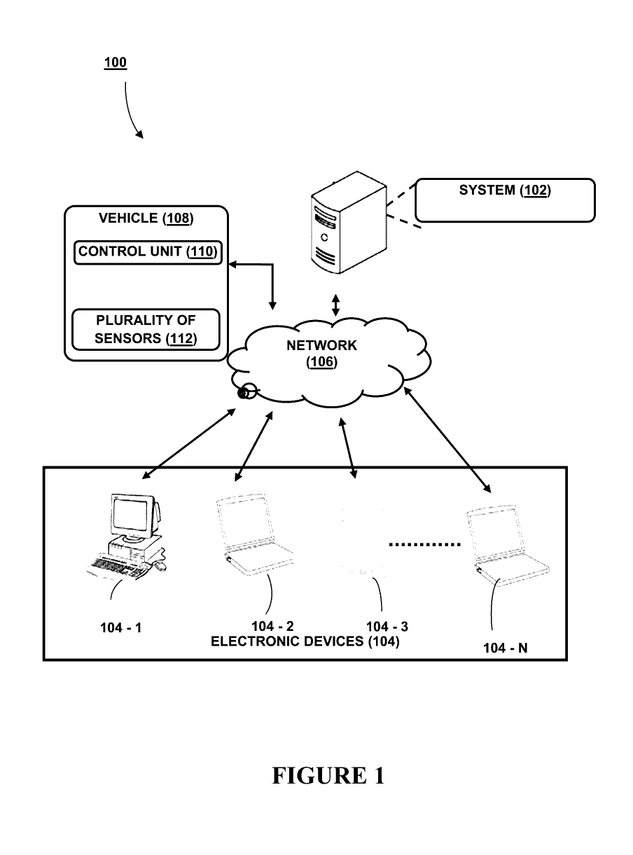

Referring now to FIG. 1, a network implementation 100 of a system 102 for authenticating a driver based on his driving style. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by multiple users through one or more user devices 104-1, 104-2, 104-3, 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Constrained Application Protocol (CoAP), Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

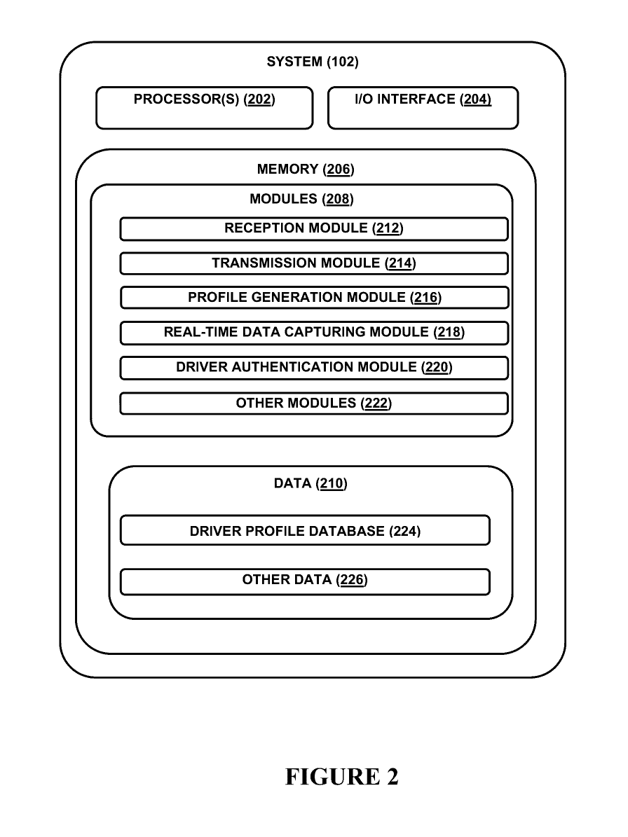

Furthermore, the system 102 may be communicatively coupled with a vehicle 108 using the network 106. The vehicle 108 comprises a control unit 110 and a plurality of sensors 112. Initially, the plurality of sensors 112 are configured to capture the driving style of an authorized user while driving the vehicle 108. The driving style of the authorized user is used to generate a driver profile of the authorized user. In one embodiment, the driver profile may be stored in the control unit 110 or in a database at the system 102. Once the driver profile is generated, in the next step, the system 102 is configured to monitor a real-time data received from the plurality of sensors 112, when the vehicle 108 is driven by a driver. Further, the system 102 is configured to compare the real-time data with driver profile in order to authenticate the driver. If the driver is the same as the authorized user of the vehicle, the real-time data will match with the driver profile leading to positive authentication of the driver. However, if the driver and authorized users are different, in this case the real-time data will not match and lead to authentication failure. The process of authenticating the driver using driving style is further explained with respect to the FIG. 2.

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks, functions or implement particular abstract data types. In one implementation, the modules 208 may include a reception module 212, a transmission module 214, a profile generation module 216, a real-time data capturing module 218, a driver authentication module 220, and other modules 222. The other modules 222 may include programs or coded instructions that supplement applications and functions of the system 102.

The data 210, amongst other things, serves as a repository for storing data processed, received, and generated by one or more of the modules 208. The data 210 may also include a driver profile database 224 and other data 226. The driver profile database 224 is configured to store driver profile of at least one authorized user of the vehicle 108. The driver profile is generated by capturing a driving style of the authorized user by the profile generation module 216. For capturing the driving style, initially the profile generation module 216 is enabled to capture reference data from the plurality of sensors 112 installed in the vehicle 108 when the authorized user is driving the vehicle 108. The plurality of sensors includes a position sensor, a pressure sensor, and one or more environmental sensors. The position sensor is configured to determine a point of contact of the authorized user with an internal component. The internal component may be selected from brake pedal, handbrake, accelerator paddle, steering wheel, gear lever, mirror and clutch pedal. The position sensor is configured to determine a portion/place of the internal component to which the authorized user is touching the internal component on frequent bases.

Further, the pressure sensor is configured to determine the average pressure applied by the authorized user over the internal component while drivin the vehicle 108. Further, the environmental sensor is configured to determine one or more external parameters in which the vehicle 108 is driven. The one or more external parameters may include environmental conditions (wind, raining, sun light), road condition (city road, highway, road wear and tear), traffic conditions, and time of the day at which the authorized user is driving the vehicle 108. Once the reference data is captured from the plurality of sensors, the driver profile is generated using the reference data. In one embodiment, the driver profile may be stored in the control unit 110 of the vehicle 108 or the profile database 224 in the system 102.

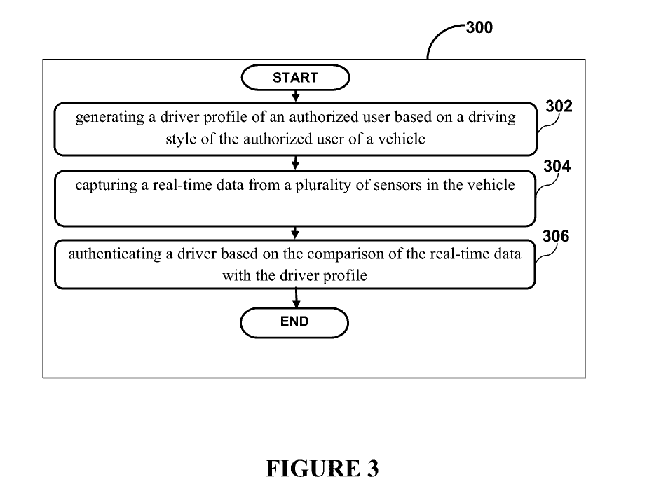

Once the driver profile is generated and stored, in the next step, the process of authenticating the driver starts by capturing the real-time data from the plurality of sensors 112 when the vehicle is driven by a driver. The real-time data is captured by the real-time data capturing module 218, wherein real-time data is indicative of driving style of the driver who is currently driving the vehicle 108. This real-time data is compared with the driver profile of the authorized driver by the driver authentication module 220. The difference between the driver profile and the real-time data is compared with a predetermined threshold value by the driver authentication module 220. If the difference between the driver profile and the real-time data is below the predefined threshold value, the driver is identified as the authenticated user of the vehicle 108 by the driver authentication module 220. However, if the difference between the driver profile and the real-time data is more than the predefined threshold value, then the driver is identified as an authenticated user of the vehicle 108 by the driver authentication module 220. Once the unauthenticated user is determined, in the next step, the driver authentication module 220 may generate an alarm signal in the vehicle, or instruct the driver to stop the vehicle 108, or inform the authenticated user of the vehicle 108 about an unauthorized use of his vehicle 108. Further, if the driver is found to be the authenticated user of the vehicle 108, then the authentication module 220 is configured to refine the driver profile based on the real-time data. The process of driver authentication is further explained with respect to the flowchart of FIG. 3.

FIG. 3 represent a block diagram for driver authentication using his driving style. At block 302, the profile generation module 216 is configured to generate driver profile by capturing a driving style of the authorized user. For capturing the driving style, initially the profile generation module 216 is enabled to capture reference data from the plurality of sensors 112 installed in the vehicle 108, while the authorized user is driving the vehicle 108. The plurality of sensors includes a position sensor, a pressure sensor, and one or more environmental sensors. The position sensor is configured to determine a point of contact of the authorized user with an internal component. The internal component may be selected from brake pedal, handbrake, accelerator paddle, steering wheel, gear lever, mirror and clutch pedal. The position sensor determines the exact portion of the internal component to which the authorized user touching the internal component on frequent bases. Further, the pressure sensor is configured to determine the pressure applied by the authorized user over the internal component of the vehicle 108. Further, the environmental sensor is configured to determine one or more external parameters in which the vehicle 108 is driven. The one or more external parameters may include environmental conditions (wind, raining, sun light), road condition (city road, highway, road wear and tear), traffic conditions, and time of the day at which the authorized user is driving the vehicle 108. Once the reference data is captured from the plurality of sensors, the driver profile is generated using the reference data.

At Block 304, once the driver profile is generated and stored in the driver profile database 224, in the next step, the process of authenticating a driver driving the vehicle 108 starts by capturing the real-time data from the plurality of sensors 112 installed in the vehicle. The real-time data is captured by the real-time data capturing module 218, wherein real-time data is indicative of the driving style of the driver who is currently driving the vehicle 108.

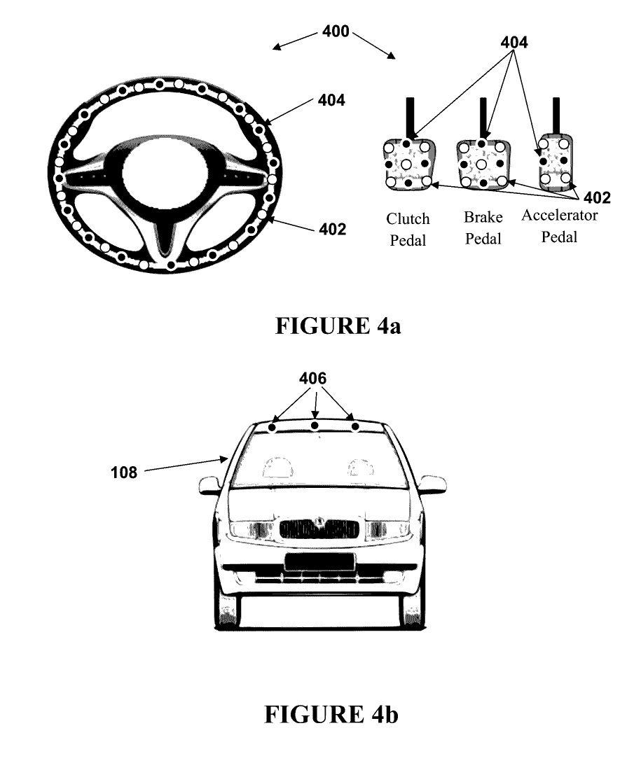

At block 306, the real-time data is compared with the driver profile of the authorized user by the driver authentication module 220. Further, the difference between the driver profile and the real-time data is compared with a predetermined threshold value by the driver authentication module 220. If the difference between the driver profile and the real-time data is below the predefined threshold value, the driver is identified as the authenticated user of the vehicle 108 by the driver authentication module 220. However, if the difference between the driver profile and the real-time data is more than the predefined threshold value, then the driver is identified as an authenticated user of the vehicle 108 by the driver authentication module 220. Further, if the driver is found to be the authenticated user of the vehicle 108, then the authentication module 220 is configured to refine the driver profile based on the real-time data. Further, the process of capturing the reference data from the plurality of sensors 112 is disclosed with reference to FIG. 4a and FIG. 4b.

FIG. 4a discloses internal components 400 and a plurality of sensors 112 linked with the internal components 400. The internal components 400 may include a steering wheel, clutch pedal, brake pedal, and an accelerator pedal of the vehicle 108. The plurality of sensors 112 include a set of position sensors 402, wherein the set of position sensors 402 are configured to determine the exact position/ point of contact at which the driver prefers to keep his hands or legs for the maximum time, while driving the vehicle 108. Further, the plurality of sensors 112 includes a set of pressure sensors 404. The set of pressure sensors 404 is configured to determine the pressure applied by the driver on the internal components 400, while driving the vehicle 108.

FIG. 4b discloses the vehicle 108 enabled with a set of environmental sensors 406 on the roof top of the vehicle 108. The set of environmental sensors 406 are configured to determine one or more external parameters, wherein the external parameters may include environmental conditions (wind, raining, sun light), road condition (city road, highway, road wear and tear), traffic conditions, and time of the day at which the driver is driving the vehicle 108. The set of position sensors 402, the set of pressure sensors 404, and the set of environmental sensors 406 are used to capture reference data for generating the driver profile of the authorized user as well as capture real-time data for authenticating the driver of the vehicle 108.

Although implementations of methods and systems for driver authentication using driving style is disclosed, it is to be understood that the appended claims are not necessarily limited to the specific features or methods described herein. Rather, the specific features and methods are disclosed as examples of implementations for driver authentication using driving style.

We claim:

1. A method for driver authentication based on a driving style, the method comprising:
generating, by a processor, a driver profile based on a driving style of an authorized user of a vehicle, wherein the driving style is captured from the authorized user by,
capturing reference data from a plurality of sensors, wherein the reference data comprises
a point of contact of the authorized user with an internal component,
a pressure applied by the authorized user over the internal component, and
one or more external parameters;
generating the driver profile based on the reference data;
capturing, by the processor, a real-time data from the plurality of sensors, wherein the vehicle is driven by a driver; and
authenticating, by the processor, the driver based on the comparison of the real-time data with the driver profile.

2. The method of claim 1, wherein the internal component is at least one of a brake pedal, handbrake, accelerator paddle, steering wheel, gear lever, mirror, and clutch.

3. The method of claim 1, wherein the plurality of sensors include a position sensor for detecting the point of contact of the authorized user with the internal component, a pressure sensor for detecting the pressure applied by the authorized user over the internal component, and an environmental sensor for detecting one or more external parameters.

4. The method of claim 1, wherein the one or more external parameters comprise environmental conditions, road condition, traffic, and time of the day.

5. The method of claim 1, wherein the driver profile is updated based on the comparison between the real-time data and the driver profile.

6. The method of claim 1, wherein the driver is authenticated if the difference between the real-time data and the driver profile is below a predefined threshold level.

7. A system for driver authentication based on a driving style, the system comprising:
a processor;
a memory coupled to the processor, wherein the processor is configured to execute a set of instructions stored in the memory for:
generating a driver profile based on a driving style of an authorized user of a vehicle, wherein the driving style is captured from the authorized user by,
capturing reference data from a plurality of sensors, wherein the reference data comprises
a point of contact of the authorized user with an internal component,
a pressure applied by the authorized user over the internal component, and
one or more external parameters;
generating the driver profile based on the reference data;
capturing a real-time data from the plurality of sensors, wherein the vehicle is driven by a driver; and
authenticating the driver based on the comparison of the real-time data with the driver profile.

8. The system of claim 7, wherein the internal component is at least one of a brake pedal, handbrake, accelerator paddle, steering wheel, gear lever, mirror, and clutch.

9. The system of claim 7, wherein the plurality of sensors include a position sensor for detecting the point of contact of the authorized user with the internal component, a pressure sensor for detecting the pressure applied by the authorized user over the internal component, and an environmental sensor for detecting one or more external parameters.

10. The system of claim 7, wherein the one or more external parameters comprise environmental conditions, road condition, traffic, and time of the day.

11. The system of claim 7, wherein the driver profile is updated based on the comparison between the real-time data and the driver profile.

12. The system of claim 7, wherein the driver is authenticated if the difference between the real-time data and the driver profile is below a predefined threshold level.

13. A computer program product having embodied thereon a computer program for driver authentication based on a driving style, the computer program product comprising:
a program code for generating a driver profile based on a driving style of an authorized user of a vehicle, wherein the driving style is captured from the authorized user by,
capturing a reference data from a plurality of sensors, wherein the reference data comprises
a point of contact of the authorized user with an internal component,
a pressure applied by the authorized user over the internal component, and
one or more external parameters;
generating the driver profile based on the reference data;
a program code for capturing a real-time data from the plurality of sensors, wherein the vehicle is driven by a driver; and
a program code for authenticating the driver based on the comparison of the real-time data with the driver profile.
